(19) United States
(12) Patent Application Publication
(10) Pub. No.: US 2007/0189461 A1
(43) Pub. Date: Aug. 16, 2007

(54) Device for positioning a patient

(76) Inventor: Andres Sommer, Langensendelbach (DE)

Correspondence Address: BRINKS HOFER GILSON & LIONE, P.O. BOX 10395, CHICAGO, IL, 60610, US

(21) Appl. No.: 11/630,755

(22) PCT Filed: Jun. 28, 2005
(86) PCT No.: PCT/EP05/53020

§ 371 Date: Dec. 22, 2006

(30) Foreign Application Priority Data
Jul. 1, 2004 (DE) 102004032012.8

(51) Int. Cl. G03B 42/02

(52) U.S. Cl. 378/178

(57) ABSTRACT

A device for positioning a patient in a seated position is provided. The device may be used for radiation treatment. The device includes a patient chair mechanically coupled with a motor-driven adjustment unit. The patient chair is an interchangeable seat shell including a seat area that is reversibly coupled to the adjustment unit and a backrest that comprises a radiation-permeable material. The backrest being displaceable relative to the seat area.

The present patent document is a continuation of PCT Application Ser. No. PCT/EP2005/053020, filed Jun. 28, 2005, designating the United States, and claims benefit of DE 10 2004 032 012.8, filed Jul. 1, 2004, both of which are hereby incorporated by reference.

The present embodiments relate to a device for positioning a patient in a seated position for radiation treatments. German Patent Disclosure DE 100 25 913 A1 discloses a device for positioning a patient in a seated position.

The device disclosed in DE 100 25 913 A1 is intended for positioning a patient who has a tumor in the head and neck region. The device includes a patient chair with a backrest coupled mechanically to a cantilevered platform via a plurality of drive units. The patient chair may be rotated or translationally supported about various axes. The patient chair is made from steel or other materials that have high rigidity to attain high positioning precision. Despite its very complicated construction, the device is intended solely for patients with a tumor in the head and neck region.

### SUMMARY

A device for positioning a patient in a seated posture for radiation treatments is disclosed which includes a structurally simple construction and offers expanded possibilities of use.

In one embodiment, a device has an interchangeable seat shell as a patient chair. The interchangeability refers to the reversible connection of the seat shell with a motor-driven adjustment unit. The seat area of the seat shell may be coupled mechanically to the adjustment unit. In one embodiment, the backrest of the seat shell is not directly mechanically coupled to the adjustment unit. The backrest is embodied such that when radiation is administered to the patient, the radiation can pass through the backrest. In this embodiment, the device is suitable for administering radiation to a patient in the head and neck region and also as low as the pelvic region. “Clean” Specification

In one embodiment, the motor-driven adjustment unit does not limit the possibilities for administering radiation from the head region to the pelvic region because there is no direct mechanical coupling above the seat shell between the seat shell and the motor-driven adjustment unit. At least in the region through which radiation is to pass, the seat shell is made from materials that cause little attenuation of the radiation used for the treatment and/or examination, and that produce few artifacts, if any. The treatment and/or examination may use photon, electron, or particle radiation, in particular carbon ion or proton radiation.

In one embodiment, the seat shell is embodied such that the patient can be partially or completely immobilized in it. The seat shell has adjustable bracing elements and/or fastening devices for separate bracing elements. Adjustable bracing elements integrated with the seat shell are a footrest, armrests, and a headrest. Additional bracing elements can be secured to the seat shell. The additional bracing elements are face masks, abdominal masks, and whole-body masks. For the head and the abdomen, a stereotactical frame can be used, to the extent necessary. In contrast to the motor-driven adjustment unit, the seat shell, which includes various immobilizing mounts, tilting elements, and displacement elements, may not have an electrical drive mechanism.

The seat shell is connected with the adjustment unit. In this embodiment, the seat shell is translationally and rotationally adjustable, and is easily undone from the adjustment unit.

In one embodiment, the patient may be positioned on the seat shell outside the radiation room. The positioned and optionally immobilized patient can be brought to the radiation room using a transport system. The patient is then transferred from this transport system by a motorized drive system and positioned in the isocenter of the radiation system. Preparing the patient for the radiation outside the treatment room makes it easier to position him in an anatomically correct posture, which in turn considerably reduces the effect of breathing motions on the abdominal organs. “Clean” Specification

In one embodiment, without lessening the radiation quality, a complicated proton or ion gantry, as disclosed in German Patent Disclosure DE 199 04 675 A1, is not needed. In one embodiment, it is easy to verify the immobilized patient on the seat shell that is located outside the radiation room because of the separation of the seat shell and the adjustment unit. The device may be used with any suitable treatment or examination, for example, a vertical computed tomography or CT scanner or other imaging methods, such as an ultrasound examination.

In one embodiment, the seat shell is designed such that the patient can be placed on it with his chest facing toward the backrest. The patient's back may easily be irradiated from the front side of the chair. In this embodiment, it is unnecessary to provide the backrest with an opening so that radiation can be administered, regardless of the precise degree of radiation absorption of the backrest. In this embodiment, the entire seat shell is both lightweight and stable, which is in contrast to the adjustment unit. In one embodiment, the seat shell has no motor-driven adjustment capability.

In one embodiment, the seat shell can be coupled without tools to the adjustment unit. In one embodiment, it is easy to uncouple the radiation-permeable seat shell from the motor-driven adjustment unit, and the radiation system is not blocked during the preparation of the patient for the radiation, so that a very high degree of utilization of the radiation system can be achieved.

### BRIEF DESCRIPTION OF THE DRAWINGS

FIG. 1 shows one embodiment of a positioning device for a radiation treatment that includes a patient placed in a seat shell;

FIG. 2 shows one embodiment of the seat shell;

FIG. 3 shows one embodiment of a seat shell with an additional chin rest;

FIG. 4 shows one embodiment of a seat shell with an additional shoulder rest; “Clean” Specification

FIG. 5 shows one embodiment of the seat shell with an adjustable footrest;

FIG. 6 shows one embodiment of a seat shell with an additional handle;

FIG. 7 shows one embodiment of a seat shell with a shifted backrest for administering radiation to a patient from behind;

FIG. 8 shows one embodiment of a seat shell for administering radiation from behind with an inverse seated position; and

FIGS. 9a-c show a seat shell in various phases of the preparation for a radiation treatment.

### DETAILED DESCRIPTION

Elements corresponding to one another or functioning identically to one another are provided with the same reference numerals throughout the drawings.

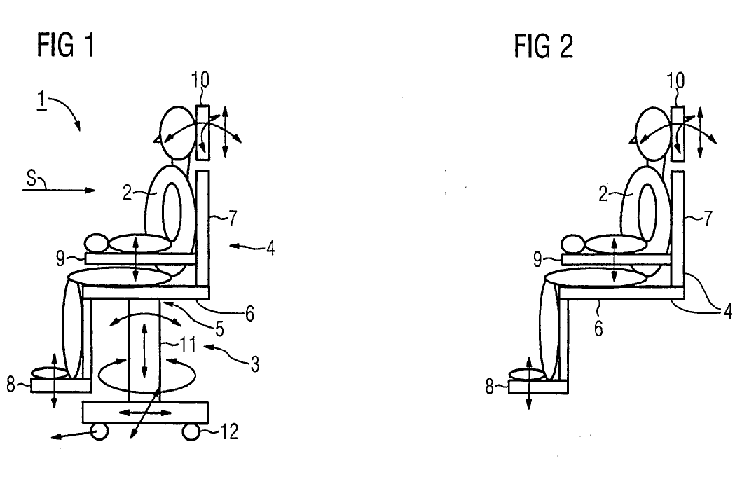

In one embodiment, as shown in FIG. 1, a device 1 for positioning a patient 2 for a radiation treatment or examination, includes a motor-driven adjustment unit 3 and a seat shell 4. The seat shell 4 is embodied as the patient's chair. The seat shell 4, shown separately in FIG. 2 with the patient 2, is connected to the adjustment unit 3 by a closure 5, for example, a snap closure. The seat shell 4 is manufactured from materials with low radiation absorption and little tendency to produce artifacts, for example, wood and/or plastic and/or carbon fiber materials. The seat shell 4 has a seat area 6, a backrest 7, footrests 8, armrests 9, and a headrest 10. In one embodiment, the footrests 8, armrests 9, and headrest 10 are manually adjustable. In the exemplary embodiment shown, the backrest 7 is not adjustable relative to the seat area 6. This adjustment is done, for example, with the aid of a drive unit. In this embodiment, the seat shell 4 is lightweight and has a stable construction.

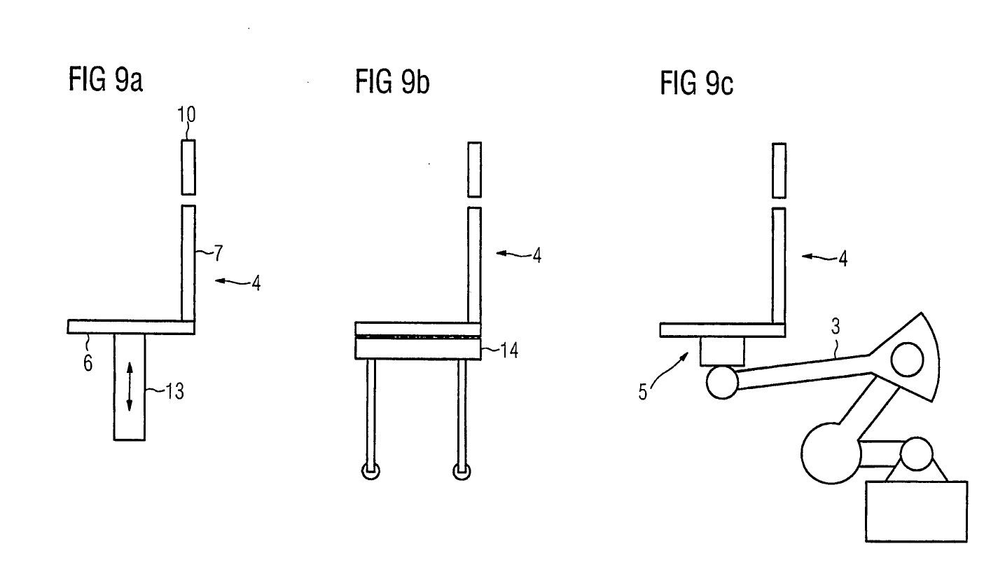

In one embodiment, the closure 5 connects the seat area 6 of the seat shell 4 to a pedestal 11 of the adjustment unit 3. The pedestal 11 is adjustable in all axes. In one embodiment, as shown in FIG. 9c, the pedestal 11 includes a support arm. “Clean” Specification

In one embodiment, the backrest 7 is joined to the adjustment unit 3 only via the seat area 6. The backrest 7 is not directly coupled with the adjustment unit 3. The backrest 7 is essentially radiation-permeable. The backrest 7 is located freely in space, which permits a radiation treatment of the patient 2 not only in the head and neck region but also in the abdominal and pelvic region. The radiation provided, which is received by the patient 2 substantially in the horizontal radiation direction S, may be electromagnetic radiation, photon radiation, or particle radiation, for example, proton or ion radiation.

In one embodiment, the patient 2 is immobilized in a manner not shown in further detail on the seat shell 4. In one embodiment, the seat shell 4 includes masks and/or frames. In one embodiment, the seat shell 4 includes stereotactical frames, vacuum cushions, belts, foam cushions, chin rests or shoulder rests, or any combinations of these elements. The various elements can be secured to the seat shell 4. In one embodiment, the patient 2 is placed on the seat shell 4 and immobilized before the seat shell 4 is placed on the adjustment unit 3. Mechanical aids (not shown) may be used to transport the seat shell 4 to the adjustment unit 3.

In one embodiment, as indicated by double arrows in FIG. 1, the adjustment unit 3 has various rotational and translational adjustment capabilities and is displaceable as a unit on rollers 12. In this embodiment, the adjustment unit makes it possible to displace the seat shell 4 in every direction in space, rotate the seat shell 4 about its vertical axis, and tilt the seat shell 4 in one or more directions. In a manner not shown, displacement of the entire adjustment unit 3 on rails may also be provided. In one embodiment, the adjustment unit 3 is adjustable using a hydraulic and/or motor, for example, electric motor, drive.

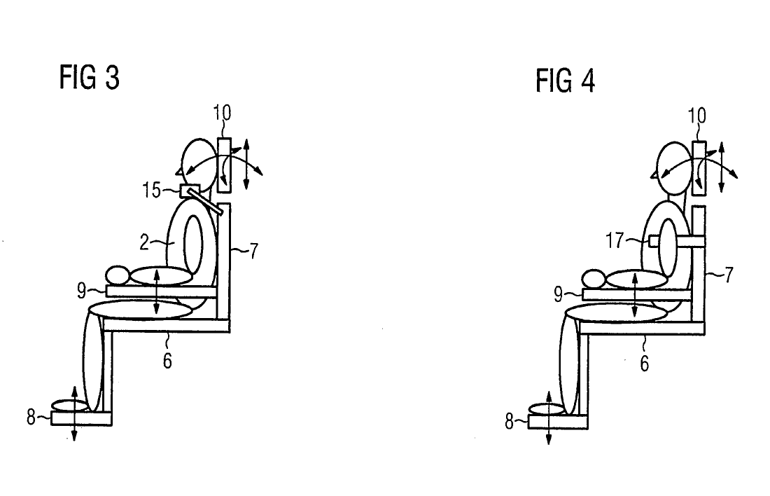

In FIGS. 3 through 6, further features of seat shells 4 are shown. In the exemplary embodiment of FIG. 3, an adjustable chin rest 15 is secured to the backrest 7. In one embodiment, as shown in FIG. 4, the seat shell 4 includes an armrest 9 and a shoulder rest 17 that are secured to the backrest 7. As shown in FIG. 5, the seat shell 4 has a shallower adjustment of the footrest 8 than that shown “Clean” Specification in FIG. 3. The adjustment of the footrest 8 is made possible by a joint 16. In this embodiment, the patient 2 may be positioned at a low level.

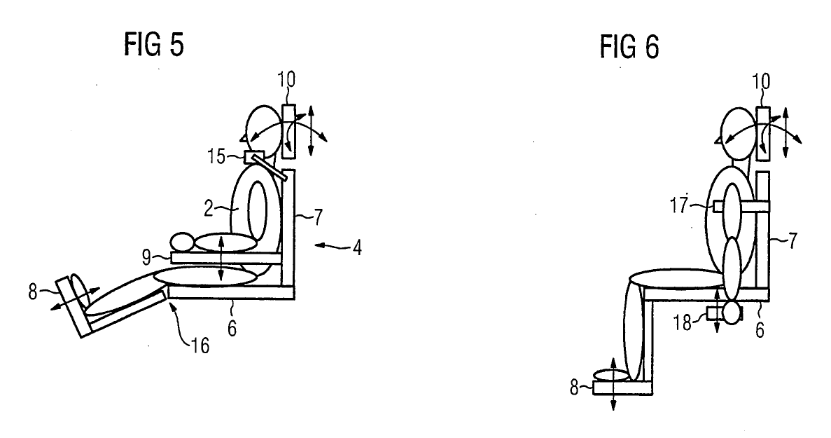

In one embodiment, as shown in FIG. 6, the seat shell 4 includes a shoulder rest 17 and a handle 18, which are secured adjustably (not shown) to the seat area 6 or to the backrest 7. In one embodiment, a seat shell 4 may also have any combination (not shown) of the bracing elements footrest 8, armrest 9, headrest 10, chinrest 15, shoulderrest 17, handle 18 that are visible in FIGS. 1 through 6.

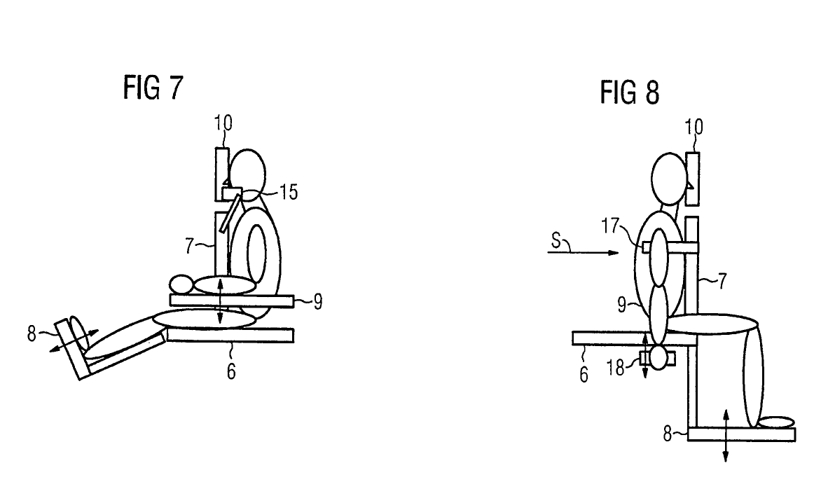

In one embodiment, as shown in FIGS. 7 and 8, the patient 2 may be positioned on the seat shell 4 in such a way that his chest is toward the backrest 7. In this position, the patient 2 may be immobilized on the seat shell 4. In this embodiment, the radiation used for the examination and/or treatment may be aimed directly at the back of the patient 2, in a substantially horizontal radiation direction S. In the exemplary embodiment shown in FIG. 7, the backrest 7 may be displaced relative to the seat area 6. In one embodiment, as shown in FIG. 7, the backrest 7 is located approximately in the middle on the seat area 6. As in the exemplary embodiments of FIGS. 1 through 6, the patient 2 is looking to the left but touches the backrest 7 with his chest. In the exemplary embodiment of FIG. 8, the patient is looking to the right, and the disposition of the backrest 7 relative to the seat area 6 is in principle equivalent to the arrangement of FIGS. 1 through 6. In this exemplary embodiment, the footrest 8 is secured to the seat area 6 in the rear region, next to the backrest 7. As shown in FIGS. 1 through 7, the footrest 8 is located in the front region.

FIGS. 9a through 9c show various phases in the preparation for a radiation treatment:. In one embodiment, as shown in FIG. 9a, the seat shell 4 is located outside the treatment room and is supported on a base 13 that is adjustable at least in the height direction. In another embodiment, as shown in FIG. 9b, the seat shell 4, is transported to the radiation room by a transport device 14. In another embodiment, as shown in FIG. 9c, the seat shell 4, with a seated patient (not shown) immobilized on it, is automatically transferred to the adjustment unit “Clean” Specification 3, using a support arm with an elbow, and put in the desired radiation position. The support arm 3 with an elbow makes it possible to manipulate a seat shell 4 in an arbitrary one of the embodiments shown in FIGS. 1 through 8.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A device for positioning a patient in a seated position, for a radiation treatment, the device comprising: having
a patient chair mechanically coupled with a motor-driven adjustment unit, characterized in that wherein the patient chair is an interchangeable seat shell including a seat area that is reversibly coupled to the adjustment unit and a backrest that comprises a radiation-permeable material, and the backrest being displaceable relative to the seat area.

2. The device as defined by claim 1, wherein the seat shell includes at least one adjustable bracing element, that immobilizes the patient, or a fastening device.

3. The device as defined by claim 2, wherein the at least one adjustable bracing element includes an adjustable footrest.

4. The device as defined by claim 2, wherein the at least one bracing element includes an adjustable armrest.

5. The device as defined by claim 2, wherein the at least one bracing element includes an adjustable chin rest.

6. The device as defined by claim 2, wherein the at least one bracing element includes an adjustable shoulder rest.

7. The device as defined by claim 2, wherein the at least one bracing element includes an adjustable handle.

8. The device as defined by claim 2, wherein the at least one bracing element includes an adjustable headrest.

9. The device as defined by claim 2, comprising a face mask.

10. The device as defined by claim 2, comprising an abdominal mask.

11. The device as defined by claim 2, comprising whole-body mask.

12. The device as defined by claim 2, comprising a stereotactical frame.

13. The device as defined by claim 2, wherein the seat shell is embodied such that the patient can be placed with his chest toward the backrest.

14. The device as defined by claim 2, wherein the at least one bracing element is secured to the seat shell.

15. The device as defined by claim 2, wherein the at least one adjustable bracing element includes an adjustable footrest, an adjustable armrest, an adjustable chin rest, an adjustable shoulder rest, an adjustable handle, an adjustable headrest, or any combination thereof.

16. The device as defined by claim 15, comprising a face mask, an abdominal mask, a whole-body mask, a stereotactical frame, or any combination thereof.

17. A method for positioning a patient in a seated position for radiation treatment comprising:
positioning the patient on a seat shell, which includes a backrest that is displaceable to a seat are, wherein the seat area may be operably coupled to an adjustment unit;
immobilizing the patient using at least one adjustable bracing element; and
transferring the patient to an isocenter of a radiation system.

18. The method for positioning the patient as defined in claim 17, wherein the patient is positioned on the seat shell outside a radiation room comprising the radiation system; and transferring the patient includes using a motorized drive system.
